(19) United States
(12) Patent Application Publication
(10) Pub. No.: US 2023/0296239 A1
(43) Pub. Date: Sep. 21, 2023

(54) NEW WATERPROOF STRING LAMP AND COMPONENT STRUCTURE THEREOF

(71) Applicant: XINJIANG ZOU, Meizhou City (HK)

(72) Inventor: XINJIANG ZOU, Meizhou City (HK)

(21) Appl. No.: 17/655,304

(22) Filed: Mar. 17, 2022

(51) Int. Cl. F21V 31/00; F21V 23/06; F21V 19/00; F21S 4/10

(52) U.S. Cl. CPC F21V 31/005; F21V 23/06; F21V 19/0005; F21S 4/10; F21W 2121/04

(57) ABSTRACT

The present disclosure discloses a new waterproof string lamp and a component structure thereof. The new waterproof string lamp comprises a plastic lamp holder, a light-transmitting lampshade, a light-emitting bulb, and positive and negative leads, wherein a lamp holder accommodating cavity is formed in the core of the plastic lamp holder; the wire core of the positive lead is welded or riveted to the positive electrical terminal, and the wire core of the negative lead is welded or riveted to the negative electrical terminal; a plastic inner plug and a plastic bulb holder are embedded in the lamp holder accommodating cavity, the plastic inner plug is provided with a resistor, the light-emitting bulb is provided in the plastic bulb holder,The new waterproof string lamp has the advantages of new structural design, excellent stability and reliability and good use effect.

### TECHNICAL FIELD

The present disclosure relates to the technical field of string lamps, in particular to a new waterproof string lamp and a component structure thereof.

### BACKGROUND

During the Christmas period, it is still necessary for Christmas to decorate the holiday with Christmas trees in order to set off the festive atmosphere. In order to improve the decoration of Christmas trees, string lamps are often hung on the Christmas tree, and string lamps have become essential decorations for Christmas.

Because Christmas string lamps are often used in outdoor environment, the waterproof performance of string lamps is relatively high.

In addition, there are various string lamp structures in the prior art. For the existing Christmas string lamps, when one of the string lamps fails, the whole Christmas string lamps will go out, and the use effect is poor.

### SUMMARY

The purpose of the present disclosure is to provide a new waterproof string lamp aiming at the shortcomings of the prior art, which is new in structural design and excellent in stability and reliability.

Another object of the present disclosure is to provide a component structure of a waterproof string lamp, which is new in structural design and excellent in stability and reliability. When one of the string lamps fails to emit light, the whole string lamp component can still keep the light-emitting state.

In order to achieve the above purpose, the present disclosure is realized by the following technical scheme.

A new waterproof string lamp comprises a plastic lamp holder, a light-transmitting lampshade, a light-emitting bulb, a positive lead and a negative lead, wherein a lamp holder accommodating cavity which completely penetrates from top to bottom is formed in the core of the plastic lamp holder;

the wire core of the positive lead is welded or riveted to the positive electrical terminal, the wire core of the negative lead is welded or riveted to the negative electrical terminal, the positive electrical terminal and the negative electrical terminal are inserted into the lamp holder accommodating cavity of the plastic lamp holder, respectively, and the positive electrical terminal and the negative electrical terminal are arranged at opposite intervals;

a plastic inner plug is embedded in the lamp holder accommodating cavity of the plastic lamp holder, the plastic inner plug is located between the positive electrical terminal and the negative electrical terminal, the plastic inner plug is provided with a resistor, the positive pin of the resistor is in contact with and in electrical conduction with the positive electrical terminal, and the negative pin of the resistor is in contact with and in electrical conduction with the negative electrical terminal;

a plastic bulb holder located at the lower end side of the plastic inner plug is also embedded in the lamp holder accommodating cavity of the plastic lamp holder, the light-emitting bulb is provided at the lower end of the plastic bulb holder, the positive pin of the light-emitting bulb is in contact with and in electrical conduction with the positive electrical terminal, and the negative pin of the light-emitting bulb is in contact with and in electrical conduction with the negative electrical terminal.

The new waterproof string lamp further comprises a heat-shrinkable sleeve, the lower end of the heat-shrinkable sleeve is sleeved on the periphery of the upper end of the plastic lamp holder, and the lower end of the heat-shrinkable sleeve clasps the upper end of the plastic lamp holder;

an isolation column is provided between the positive lead and the negative lead, the upper end of the heat-shrinkable sleeve is sleeved on the periphery of the isolation column, the upper end of the heat-shrinkable sleeve clasps the isolation column, and the positive lead and the negative lead are clasped by the isolation column and the heat-shrinkable sleeve, respectively.

The plastic lamp holder comprises a lamp holder main body and a lampshade mounting cap which is injection molded with the lamp holder main body, the lamp holder accommodating cavity is formed in the core of the lamp holder main body, the heat-shrinkable sleeve is sleeved on the periphery of the upper end of the lamp holder main body, and the lampshade mounting cap is formed with a lampshade mounting cavity with a downward opening;

the upper end of the light-transmitting lampshade is embedded into the lampshade mounting cavity of the lampshade mounting cap, and the upper end of the light-transmitting lampshade is connected with the lampshade mounting cap.

The inner wall of the lampshade mounting cavity is provided with an internal thread, the upper end of the light-transmitting lampshade is provided with an external thread, and the external thread of the light-transmitting lampshade is screwed with the internal thread of the lampshade mounting cap.

The upper end of the light-transmitting lampshade is buckled with the lampshade mounting cap.

The lampshade mounting cap is provided with a ring-shaped rib in the shape of a circle, and the ring-shaped rib and the lampshade mounting cap are integrated;

the upper end of the light-transmitting lampshade surrounds the periphery of the ring-shaped rib, and the ring-shaped rib abuts against and is in contact with the inner wall of the light-transmitting lampshade, and the abutting contact surface between the ring-shaped rib and the inner wall of the light-transmitting lampshade forms a waterproof groove structure.

The lampshade mounting cap is provided with a top waterproof line in the shape of a circle surrounding the periphery of the ring-shaped rib, and the top waterproof line abuts against and is in contact with the top surface of the light-transmitting lampshade.

The plastic lampshade is provided with a hook, and the hook and the plastic lampshade are injection molded into an integrated structure.

The positive electrical terminal and the negative electrical terminal are copper terminals, respectively.

A component structure of a waterproof string lamp comprises a plurality of waterproof string lamps described above; the component structure of the waterproof string lamp further comprises a power cord, a male connector provided at one end of the power cord, and a female connector provided at the other end of the power cord, and all the waterproof string lamps are arranged at intervals along the power cord in sequence; and the positive lead and the negative lead of each waterproof string lamp are part of the power cord, respectively.

The beneficial effects of the present disclosure are as follows. A new waterproof string lamp according to the present disclosure comprises a plastic lamp holder, a light-transmitting lampshade, a light-emitting bulb, a positive lead and a negative lead, wherein a lamp holder accommodating cavity which completely penetrates from top to bottom is formed in the core of the plastic lamp holder; the wire core of the positive lead is welded or riveted to the positive electrical terminal, the wire core of the negative lead is welded or riveted to the negative electrical terminal, the positive electrical terminal and the negative electrical terminal are inserted into the lamp holder accommodating cavity of the plastic lamp holder, respectively, and the positive electrical terminal and the negative electrical terminal are arranged at opposite intervals; a plastic inner plug is embedded in the lamp holder accommodating cavity of the plastic lamp holder, the plastic inner plug is located between the positive electrical terminal and the negative electrical terminal, the plastic inner plug is provided with a resistor, the positive pin of the resistor is in contact with and in electrical conduction with the positive electrical terminal, and the negative pin of the resistor is in contact with and in electrical conduction with the negative electrical terminal; a plastic bulb holder located at the lower end side of the plastic inner plug is also embedded in the lamp holder accommodating cavity of the plastic lamp holder, the light-emitting bulb is provided at the lower end of the plastic bulb holder, the positive pin of the light-emitting bulb is in contact with and in electrical conduction with the positive electrical terminal, and the negative pin of the light-emitting bulb is in contact with and in electrical conduction with the negative electrical terminal. Through the structural design, the new waterproof string lamp according to the present disclosure has the advantages of new structural design, excellent stability and reliability and good use effect.

Another beneficial effect of the present disclosure is that the component structure of the waterproof string lamp according to the present disclosure comprises a plurality of waterproof string lamps described above; the component structure of the waterproof string lamp further comprises a power cord, a male connector provided at one end of the power cord, and a female connector provided at the other end of the power cord, and all the waterproof string lamps are arranged at intervals along the power cord in sequence; and the positive lead and the negative lead of each waterproof string lamp are part of the power cord, respectively. Through the structural design, the component structure of the waterproof string lamp according to the present disclosure has the advantages of new structural design, excellent stability and reliability and good use effect.

### BRIEF DESCRIPTION OF THE DRAWINGS

The drawings will be used to further explain the present disclosure hereinafter, but the embodiments in the drawings do not constitute any limitation on the present disclosure.

FIG. 1 is a schematic structural diagram of a new waterproof string lamp according to the present disclosure.

FIG. 2 is an exploded schematic diagram of a new waterproof string lamp according to the present disclosure.

FIG. 3 is a schematic sectional view of a new waterproof string lamp according to the present disclosure.

FIG. 4 is a schematic sectional view of another embodiment of a new waterproof string lamp according to the present disclosure.

FIG. 5 is a schematic structural diagram of a component structure of a waterproof string lamp.

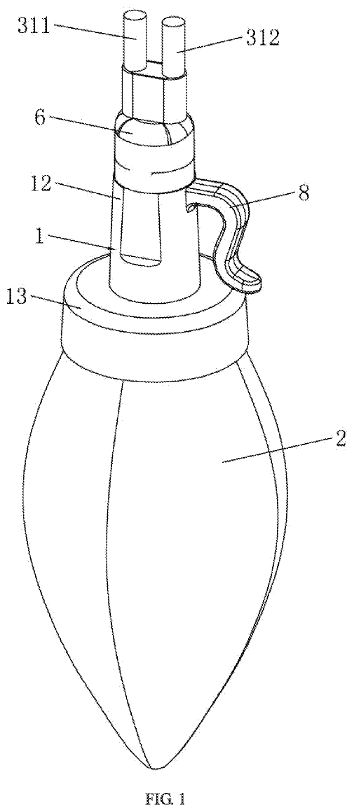

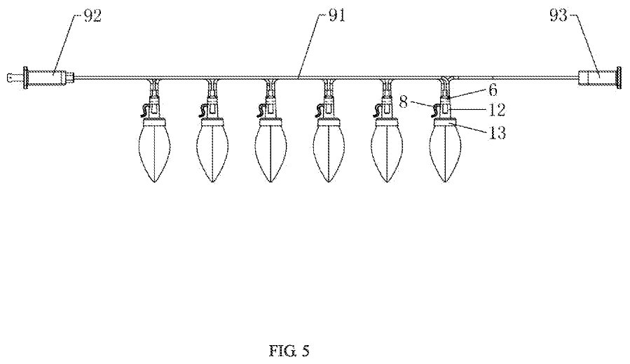

In FIGS. 1 to 5:

1—plastic lamp holder, 11—lamp holder accommodating cavity

12—lamp holder main body, 13—lampshade mounting cap

131—lampshade mounting cavity, 132—internal thread

133—ring—shaped rib, 134—top waterproof line

2—light—transmitting lampshade, 21—external thread

311—positive lead, 312—positive electrical terminal

321—negative lead, 322—negative electrical terminal

41—plastic inner plug, 42—resistor

51—plastic bulb holder, 52—light—transmitting bulb

6—heat—shrinkable sleeve, 7—isolation column

8—hook, 91—power cord

92—male connector, 93—female connector

### DETAILED DESCRIPTION OF THE EMBODIMENTS

The present disclosure will be described with reference to specific embodiments hereinafter.

In Embodiment 1, as shown in FIG. 1 to FIG. 4, a new waterproof string lamp comprises a plastic lamp holder 1, a light-transmitting lampshade 2, a light-emitting bulb 52, a positive lead 311 and a negative lead 321, wherein a lamp holder accommodating cavity 11 which completely penetrates from top to bottom is formed in the core of the plastic lamp holder 1. It should be pointed out that, as shown in FIG. 1 to FIG. 4, in order to facilitate the hanging and installation of string lamps, Embodiment 1 uses the following structural design. Specifically, the plastic lampshade is provided with a hook 8, and the hook 8 and the plastic lampshade are injection molded into an integrated structure.

The wire core of the positive lead 311 is welded or riveted to the positive electrical terminal 312, the wire core of the negative lead 321 is welded or riveted to the negative electrical terminal 322, the positive electrical terminal 312 and the negative electrical terminal 322 are inserted into the lamp holder accommodating cavity 11 of the plastic lamp holder 1, respectively, and the positive electrical terminal 312 and the negative electrical terminal 322 are arranged at opposite intervals. Preferably, the positive electrical terminal 312 and the negative electrical terminal 322 are copper terminals, respectively.

Further, a plastic inner plug 41 is embedded in the lamp holder accommodating cavity 11 of the plastic lamp holder 1, the plastic inner plug 41 is located between the positive electrical terminal 312 and the negative electrical terminal 322, the plastic inner plug 41 is provided with a resistor 42, the positive pin of the resistor 42 is in contact with and in electrical conduction with the positive electrical terminal 312, and the negative pin of the resistor 42 is in contact with and in electrical conduction with the negative electrical terminal 322;

Still further, a plastic bulb holder 51 located at the lower end side of the plastic inner plug 41 is also embedded in the lamp holder accommodating cavity 11 of the plastic lamp holder 1, the light-emitting bulb 52 is provided at the lower end of the plastic bulb holder 51, the positive pin of the light-emitting bulb 52 is in contact with and in electrical conduction with the positive electrical terminal 312, and the negative pin of the light-emitting bulb 52 is in contact with and in electrical conduction with the negative electrical terminal 322.

It should be pointed out that the new waterproof string lamp further comprises a heat-shrinkable sleeve 6, the lower end of the heat-shrinkable sleeve 6 is sleeved on the periphery of the upper end of the plastic lamp holder 1, and the lower end of the heat-shrinkable sleeve 6 clasps the upper end of the plastic lamp holder 1; an isolation column 7 is provided between the positive lead 311 and the negative lead 321, the upper end of the heat-shrinkable sleeve 6 is sleeved on the periphery of the isolation column 7, the upper end of the heat-shrinkable sleeve 6 clasps the isolation column 7, and the positive lead 311 and the negative lead 321 are clasped by the isolation column 7 and the heat-shrinkable sleeve 6, respectively.

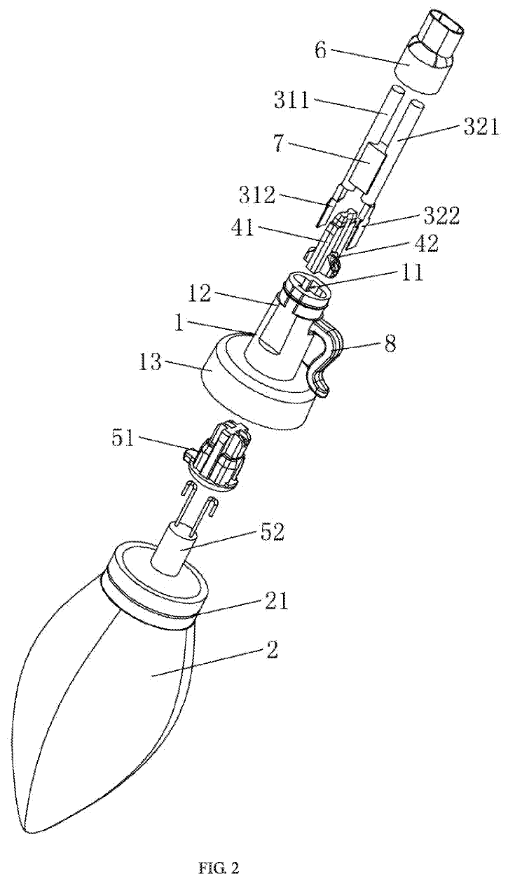

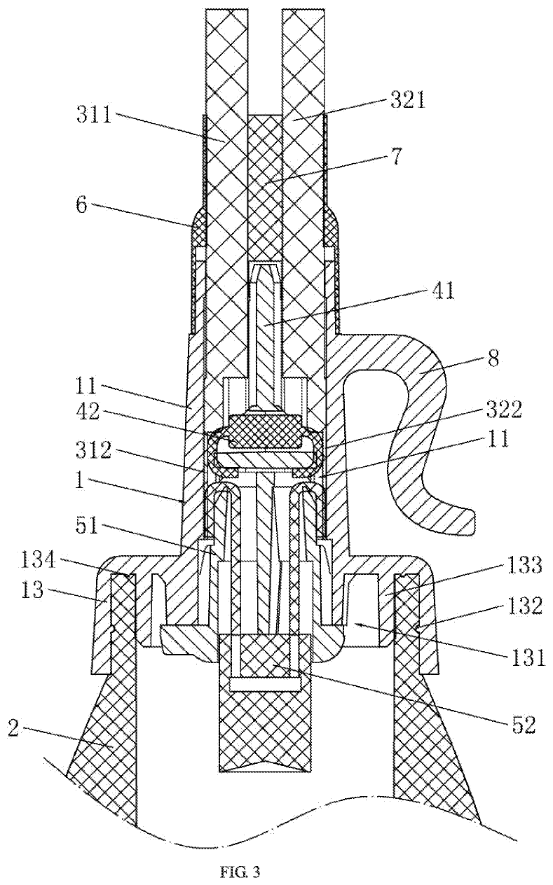

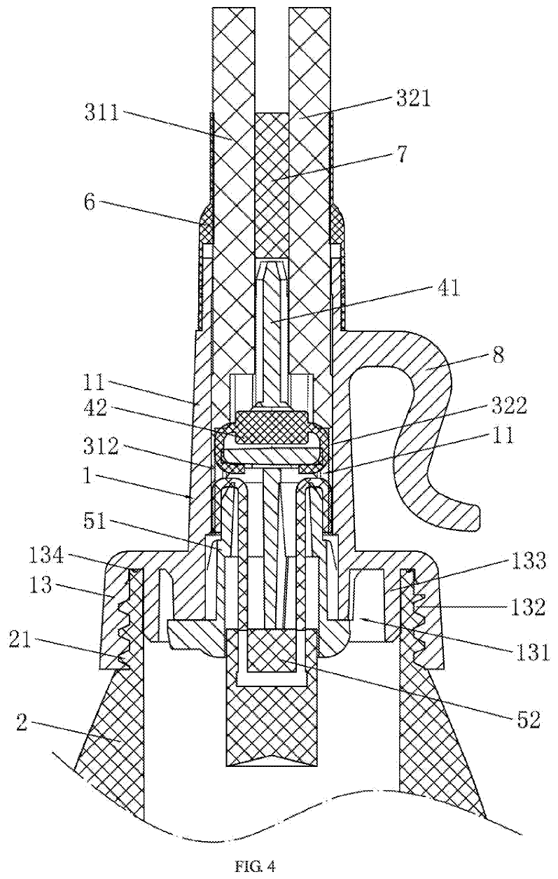

In addition, the plastic lamp holder 1 comprises a lamp holder main body 12 and a lampshade mounting cap 13 which is injection molded with the lamp holder main body 12, the lamp holder accommodating cavity 11 is formed in the core of the lamp holder main body 12, the heat-shrinkable sleeve 6 is sleeved on the periphery of the upper end of the lamp holder main body 12, and the lampshade mounting cap 13 is formed with a lampshade mounting cavity 131 with a downward opening; the upper end of the light-transmitting lampshade 2 is embedded into the lampshade mounting cavity 131 of the lampshade mounting cap 13, and the upper end of the light-transmitting lampshade 2 is connected with the lampshade mounting cap 13. Specifically, as shown in FIG. 2 and FIG. 3, the upper end of the light-transmitting lampshade 2 is buckled with the lampshade mounting cap 13, the outer circumferential surface of the upper end of the light-transmitting lampshade 2 is provided with a ring-shaped buckle groove, the lampshade mounting cap 13 is provided with a ring-shaped flange corresponding to the ring-shaped buckle groove, and the ring-shaped flange of the lampshade mounting cap 13 is buckled into the ring-shaped buckle groove of the light-transmitting lampshade 2. Of course, in addition to using the above buckling method to realize assembly and connection, the upper end of the light-transmitting lampshade 2 in Embodiment 1 can also be assembled and connected with the lampshade mounting cap 13 by screwing. Specifically, as shown in FIG. 4, the inner wall of the lampshade mounting cavity 131 is provided with an internal thread 132, the upper end of the light-transmitting lampshade 2 is provided with an external thread 21, and the external thread 21 of the light-transmitting lampshade 2 is screwed with the internal thread 132 of the lampshade mounting cap 13.

In the production and assembly process of the present disclosure, the plastic inner plug 41 provided with the resistor 42 is placed between the positive electrical terminal 312 and the negative electrical terminal 322, and then the above components are placed in the injection mold for injection molding of the plastic lamp holder 1, so as to obtain the component structure consisted of the plastic lamp holder 1, the positive lead 311, the negative lead 321, the positive electrical terminal 312, the negative electrical terminal 322, the plastic inner plug 41 and the resistor 42. After the plastic lamp holder 1 is injection molded, an isolation column 7 is installed between the positive lead 311 and the negative lead 321 to separate the positive lead 311 from the negative lead 321 at intervals by the isolation column 7, and then a heat-shrinkable sleeve 6 is installed. One end of the heat-shrinkable sleeve 6 clasps the upper end of the lamp holder main body 12 and realizes waterproof sealing connection between the heat-shrinkable sleeve 6 and the bracket of the lamp holder main body 12. The other end of the heat-shrinkable sleeve 6 clasps the isolation column 7 and clasps the positive lead 311 and the negative lead 321, so as to realize waterproof sealing of the lead position. It should be pointed out that the present disclosure can effectively realize the waterproof performance of the top position of the string lamp through the top waterproof structure consisted of the heat-shrinkable sleeve 6 and the isolation column 7.

In addition to using the top waterproof structure consisted of the heat-shrinkable sleeve 6 and the isolation column 7 to realize the waterproof performance of the top position of the string lamp, Embodiment 1 can also use the injection molding and encapsulating manner to realize the waterproof performance of the top position of the string lamp. That is, an encapsulation layer is formed on the upper end of the plastic lamp holder 1 in the injection molding and encapsulating manner, and the encapsulation layer wraps the positive lead and the negative lead. Of course, for the structural form of using the top waterproof structure consisted of the heat-shrinkable sleeve 6 and the isolation column 7 to realize the waterproof performance of the top position of the string lamp, in order to further improve the waterproof performance of the top position of the string lamp, the injection molding and encapsulating process can be carried out again. The upper end of the plastic lamp holder 1 and the positive and negative leads can be wrapped by the encapsulation layer after injection molding and encapsulating.

It should be emphasized that the positive pin of the light-emitting bulb 52 and the positive pin of the resistor 42 are in electrical conduction with the positive electrical terminal 312, respectively, and the negative pin of the light-emitting bulb 52 and the negative pin of the resistor 42 are in electrical conduction with the negative electrical terminal 322, respectively. When the present disclosure is applied to the component structure of the string lamp, all waterproof string lamps are electrically connected in series. When one of the string lamps in the component structure of the string lamp fails due to the light-emitting bulb 52, for example, the plastic bulb holder 51 or the light-emitting bulb 52 in the failed waterproof bulb is subjected to external force, so that the pins of the light-emitting bulb are separated from the positive and negative electrical terminals. The resistor 42 in the failed waterproof string lamp can still realize the circuit conduction between the positive electrical terminal 312 and the negative electrical terminal 321, so that the remaining non-fault waterproof string lamps can still emit light without being affected, which has excellent stability and reliability and good use effect.

According to the above situation, through the above structural design, the new waterproof string lamp in Embodiment 1 has the advantages of new structural design, excellent stability and reliability and good use effect.

Embodiment 2 is different from Embodiment 1 in that the lampshade mounting cap 13 is provided with a ring-shaped rib 133 in the shape of a circle, and the ring-shaped rib 133 and the lampshade mounting cap 13 are integrated; the upper end of the light-transmitting lampshade 2 surrounds the periphery of the ring-shaped rib 133, and the ring-shaped rib 133 abuts against and is in contact with the inner wall of the light-transmitting lampshade 2, and the abutting contact surface between the ring-shaped rib 133 and the inner wall of the light-transmitting lampshade 2 forms a waterproof groove structure.

It should be emphasized that the structure that the ring-shaped rib 133 abuts against and is in contact with the inner wall of the light-transmitting lampshade 2 can be used as the inner waterproof structure, and the waterproof structure design can effectively realize the waterproof sealing function between the light-transmitting lampshade 2 and the plastic lamp holder 1.

Embodiment 3 is different from Embodiment 1 in that the lampshade mounting cap 13 is provided with a top waterproof line 134 in the shape of a circle surrounding the periphery of the ring-shaped rib 133, and the top waterproof line 134 abuts against and is in contact with the top surface of the light-transmitting lampshade 2.

When the light-transmitting lampshade 2 is screwed tightly to the plastic lamp holder 1, the top surface of the light-transmitting lamp holder abuts against and is in contact with the top waterproof line 134 of the lampshade mounting cap 13. The waterproof layer structure formed by the contact of the top waterproof line 134 with the top surface of the light-transmitting lampshade 2 can further improve the waterproof effect of the waterproof string lamp.

In Embodiment 4, a component structure of a waterproof string lamp comprises a plurality of waterproof string lamps; the component structure of the waterproof string lamp further comprises a power cord 91, a male connector 92 provided at one end of the power cord 91, and a female connector 93 provided at the other end of the power cord 91, all the waterproof string lamps are arranged at intervals along the power cord 91 in sequence, and all the waterproof string lamps are electrically connected in series; and the positive lead 311 and the negative lead 321 of each waterproof string lamp are part of the power cord 91, respectively.

For the component structure of the waterproof string lamp of Embodiment 4, when the light-emitting bulb 52 in one of the waterproof string lamps fails, the remaining waterproof string lamps can still keep emitting light, which has good stability and reliability and good use effect.

The above content is only the preferred embodiment of the present disclosure. For those skilled in the art, according to the idea of the present disclosure, there will be changes in the specific implementation and application scope. The content of this specification should not be construed as a limitation of the present disclosure.

1. A waterproof string lamp, comprising a plastic lamp holder (1), a light-transmitting lampshade (2), a light-emitting bulb (52), a positive lead (311) and a negative lead (321) and, a lamp holder accommodating cavity (11) which completely penetrates from top to bottom is formed in the core of the plastic lamp holder (1), and a heat-shrinkable sleeve (6);
the wire core of the positive lead (311) is connected to a positive electrical terminal (312), the wire core of the negative lead (321) is connected to a negative electrical terminal (322), the positive electrical terminal (312) and the negative electrical terminal (322) are inserted into the lamp holder accommodating cavity (11) of the plastic lamp holder (1), respectively, and the positive electrical terminal (312) and the negative electrical terminal (322) are arranged opposite with an intervals;
a plastic inner plug (41) is embedded in the lamp holder accommodating cavity (11) of the plastic lamp holder (1), the plastic inner plug (41) is located between the positive electrical terminal (312) and the negative electrical terminal (322), the plastic inner plug (41) is provided with a resistor (42), the positive pin of the resistor (42) is in contact with and in electrical conduction with the positive electrical terminal (312), and the negative pin of the resistor (42) is in contact with and in electrical conduction with the negative electrical terminal (322);
a plastic bulb holder (51) located at the lower end side of the plastic inner plug (41) is also embedded in the lamp holder accommodating cavity (11) of the plastic lamp holder (1), the light-emitting bulb (52) is provided at the lower end of the plastic bulb holder (51), the positive pin of the light-emitting bulb (52) is in contact with and in electrical conduction with the positive electrical terminal (312), and the negative pin of the light-emitting bulb (52) is in contact with and in electrical conduction with the negative electrical terminal (322),
wherein the plastic lamp holder (1) comprises a lamp holder main body (12) and a lampshade mounting cap (13) which is injection molded with the lamp holder main body (12), the lamp holder accommodating cavity (11) is formed in the core of the lamp holder main body (12), the heat-shrinkable sleeve (6) is sleeved on the periphery of the upper end of the lamp holder main body (12), and the lampshade mounting cap (13) is formed with a lampshade mounting cavity (131) with a downward opening;
the upper end of the light-transmitting lampshade (2) is embedded into the lampshade mounting cavity (131 of the lampshade mounting cap (13), and the upper end of the light-transmitting lampshade (2) is connected with the lampshade mounting cap (13).

2. The waterproof string lamp according to claim 1, wherein the lower end of the heat-shrinkable sleeve (6) is sleeved on the periphery of the upper end of the plastic lamp holder (1), and the lower end of the heat-shrinkable sleeve (6) clasps the upper end of the plastic lamp holder (1);
an isolation column (7) is provided between the positive lead (311) and the negative lead (321), the upper end of the heat-shrinkable sleeve (6) is sleeved on the periphery of the isolation column (7), the upper end of the heat-shrinkable sleeve (6) clasps the isolation column (7), and the positive lead (311) and the negative lead (321) are clasped by the isolation column (7) and the heat-shrinkable sleeve (6), respectively.

3. (canceled)

4. The waterproof string lamp according to claim 3, wherein the inner wall of the lampshade mounting cavity (131) is provided with an internal thread (132), the upper end of the light-transmitting lampshade (2) is provided with an external thread (21), and the external thread (21) of the light-transmitting lampshade (2) is screwed with the internal thread (132) of the lampshade mounting cap (13).

5. The waterproof string lamp according to claim 3, wherein the upper end of the light-transmitting lampshade (2) is buckled with the lampshade mounting cap (13).

6. The waterproof string lamp according to claim 3, wherein the lampshade mounting cap (13) is provided with a ring-shaped rib (133) in the shape of a circle, and the ring-shaped rib (133) and the lampshade mounting cap (13) are integrated;
the upper end of the light-transmitting lampshade (2) surrounds the periphery of the ring-shaped rib (133), and the ring-shaped rib (133) abuts against and is in contact with the inner wall of the light-transmitting lampshade (2), and the abutting contact surface between the ring-shaped rib (133) and the inner wall of the light-transmitting lampshade (2) forms a waterproof groove structure.

7. The waterproof string lamp according to claim 6, wherein the lampshade mounting cap (13) is provided with a top waterproof line (134) in the shape of a circle surrounding the periphery of the ring-shaped rib (133), and the top waterproof line (134) abuts against and is in contact with the top surface of the light-transmitting lampshade (2).

8. The waterproof string lamp according to claim 1, wherein the plastic lampshade is provided with a hook (8), and the hook (8) and the plastic lampshade form an integrated structure by injection molding.

9. The waterproof string lamp according to claim 1, wherein the positive electrical terminal (312) and the negative electrical terminal (322) are copper terminals, respectively.

10. A component structure of a waterproof string lamp, comprising a plurality of waterproof string lamps according to claims 1;
the component structure of the waterproof string lamp further comprises a power cord (91), a male connector (92) provided at one end of the power cord (91), and a female connector (93) provided at the other end of the power cord (91), and all the waterproof string lamps are arranged at intervals along the power cord (91) in sequence; and the positive lead (311) and the negative lead (321) of each waterproof string lamp are part of the power cord (91), respectively.
